(19) United States
(12) Patent Application Publication
(10) Pub. No.: US 2026/0346123 A1
(43) Pub. Date: Nov. 5, 2026

(54) LOTTERY GAMING SYSTEMS AND METHODS OF OPERATING LOTTERY GAMING SYSTEMS THAT PROVIDE DRAW LOTTERY TICKETS WITH COLLECTABLE SYMBOLS

(71) Applicant: Brightstar Global Solutions Corporation, Providence, RI (US)

(72) Inventor: Ryan McShane, Cumberland, RI (US)

(21) Appl. No.: 19/198,480

(22) Filed: May 5, 2025

(51) Int. Cl. A63F 3/06

(52) U.S. Cl. CPC A63F 3/0655

(57) ABSTRACT

A lottery gaming system and method of operating a lottery gaming system that provide a draw lottery tickets with collectable symbols for drawings of a draw lottery game.

### BACKGROUND

The present disclosure relates to lottery gaming systems and methods of operating lottery gaming systems that provide draw lottery ticket with collectable symbols.

Lottery gaming systems may enable a purchaser to select numbers for a draw lottery ticket and then randomly select drawn lottery numbers. Lottery gaming systems may provide an award to the purchaser based on the quantity of matches between the drawn lottery numbers and the purchaser-selected numbers.

### BRIEF SUMMARY

In various embodiments, the present disclosure relates to a lottery gaming system comprising a lottery terminal and associated draw lottery ticket printer; and a central lottery server. The lottery central server is configured to: associate a draw lottery game with a collectable symbol set, the collectable symbol set comprising collectable symbols and associated with a winning combination of the collectable symbols; thereafter, enable purchases of draw lottery tickets for each of a plurality of drawings of the draw lottery game, wherein each of the draw lottery tickets comprises purchaser numbers for at least one of the plurality of drawings of the draw lottery game, wherein each of the draw lottery tickets comprises a quantity of the collectable symbols of the collectable symbol set, the quantity being at least one; and cause the lottery terminal and the draw lottery ticket printer to co-act to, for each of the draw lottery tickets, print the draw lottery ticket with the purchaser numbers and the collectable symbols of that draw lottery ticket. The lottery central server is further configured to: for each of the plurality of drawings of the draw lottery game: cause an indication of randomly determined drawn symbols for that drawing of the draw lottery game, and cause a determination of any award amounts based on the drawn symbols for that drawing of the draw lottery game; and enable redemption of a quantity of the draw lottery tickets that comprise collectable symbols that form the winning collectable symbol combination associated with the collectable symbol set.

In various other embodiments, the present disclosure relates to a lottery gaming system comprising a lottery terminal and associated draw lottery ticket printer and a central lottery server. The central lottery server is configured to: associate a draw lottery game with a collectable symbol set, the collectable symbol set comprising different collectable symbols and associated with a winning combination of the different collectable symbols; thereafter, enable purchases of draw lottery tickets for each of a plurality of drawings of the draw lottery game, wherein each of the draw lottery tickets comprises purchaser numbers for at least one of the plurality of drawings of the draw lottery game, wherein each of the draw lottery tickets comprises one of: a first quantity of the collectable symbols of the collectable symbol set, wherein the first quantity is zero, a second quantity of the collectable symbols of the collectable symbol set, wherein the second quantity is one, and a third quantity of the collectable symbols of the collectable symbol set, wherein the third quantity is more than one; and cause the lottery terminal and the draw lottery ticket printer to co-act to, for each of the draw lottery tickets, print the draw lottery ticket with the purchaser numbers and the collectable symbols of that draw lottery ticket. The central lottery server is further configured to: for each of the plurality of drawings of the draw lottery game: cause an indication of randomly determined drawn symbols for that drawing of the draw lottery game, and cause a determination of any award amounts based on the drawn symbols for that drawing of the draw lottery game; and enable redemption of a quantity of the draw lottery tickets that comprise collectable symbols that form the winning collectable symbol combination associated with the collectable symbol set.

In various other embodiments, the present disclosure relates to a lottery gaming system comprising a lottery terminal and associated draw lottery ticket printer and a central lottery server. The central lottery server is configured to: associate a draw lottery game with a first collectable symbol set, the first collectable symbol set comprising first collectable symbols and associated with a first winning combination of the first collectable symbols; associate a draw lottery game with a second collectable symbol set, the section collectable symbol set comprising second collectable symbols and associated with a second winning combination of the second collectable symbols; thereafter, enable purchases of draw lottery tickets for each of a plurality of drawings of the draw lottery game, wherein each of the draw lottery tickets comprises purchaser numbers for at least one of the plurality of drawings of the draw lottery game, wherein each of the draw lottery tickets comprises a first quantity of the first collectable symbols of the first collectable symbol set, wherein each of the draw lottery tickets comprises a second quantity of the second collectable symbols of the second collectable symbol set, wherein one of the first quantity and the second quantity is at least one; and cause the lottery terminal and the draw lottery ticket printer to co-act to, for each of the draw lottery tickets, print the draw lottery ticket with the purchaser numbers and any of the first collectable symbols and the second collectable symbols of that draw lottery ticket. The central lottery server is further configured to: for each of the plurality of drawings of the draw lottery game: cause an indication of randomly determined drawn symbols for that drawing of the draw lottery game, and cause a determination of any award amounts based on the drawn symbols for that drawing of the draw lottery game; and enable redemption of a quantity of the draw lottery tickets that comprise either the first collectable symbols that form the first winning collectable symbol combination associated with the first collectable symbol set or the second collectable symbols that form the second winning collectable symbol combination associated with the second collectable symbol set.

Additional features are described in, and will be apparent from, the following Detailed Description and the figures.

### BRIEF DESCRIPTION OF THE SEVERAL VIEWS OF THE DRAWINGS

FIG. 1 is front view of an example draw lottery ticket.

FIG. 2 is a flow chart of a method for operating a lottery gaming system of one example embodiment of the present disclosure.

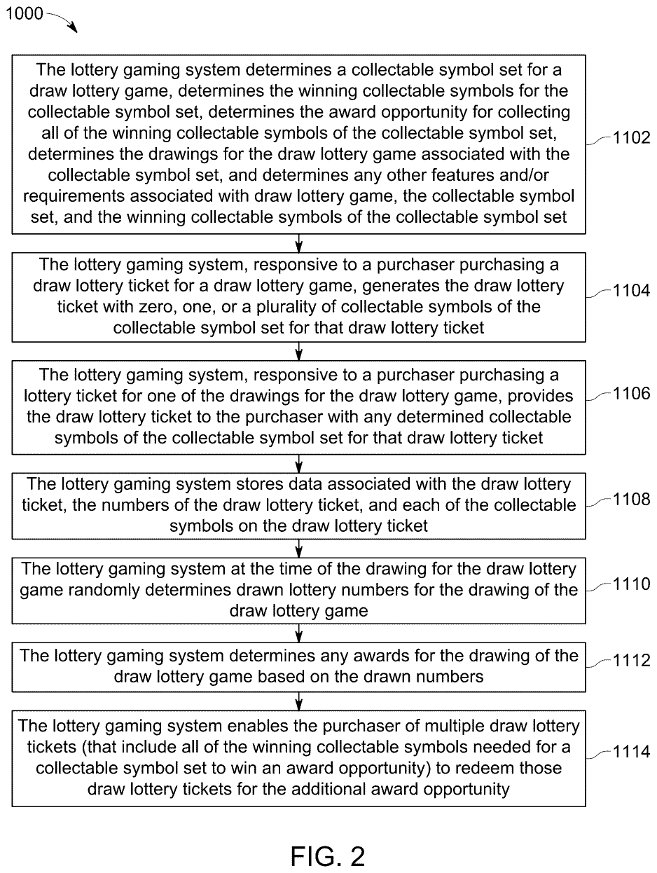

FIG. 3A is a front view of an example draw lottery ticket for a play of a draw lottery game and including two collectable symbols of a collectable symbol set in accordance with one example embodiment of the present disclosure.

FIG. 3B is a front view of another example draw lottery ticket for a play of a draw lottery game and including two collectable symbols of a collectable symbol set in accordance with one example embodiment of the present disclosure.

FIG. 3C is a front view of another example draw lottery ticket for a play of a draw lottery game and including three collectable symbols of a collectable symbol set in accordance with one example embodiment of the present disclosure.

FIG. 3D is a front view of another example draw lottery ticket for a play of a draw lottery game and including two collectable symbols from two different collectable symbol sets in accordance with one example embodiment of the present disclosure.

FIG. 3E is a front view of another example draw lottery ticket for a play of a draw lottery game and including a wild collectable symbol for a collectable symbol set in accordance with one example embodiment of the present disclosure.

FIG. 4 is a schematic diagram of a lottery gaming system of one example embodiment of the present disclosure.

### DETAILED DESCRIPTION

In various embodiments, the present disclosure relates to lottery gaming systems and methods of operating lottery gaming systems that provide draw lottery tickets for multiple drawings of draw lottery games, wherein each of the draw lottery tickets can include zero, one, or a plurality of collectable symbols of one or more collectable symbol sets, wherein the collectable symbols are collectable and usable for additional award opportunities for additional awards associated with the draw lottery tickets. The collectable symbols of the collectable symbol set(s) can be of one or more different types in accordance with the present disclosure. The present disclosure also relates to draw lottery tickets with the collectable symbols. The draw lottery tickets with the collectable symbols can be physically printed draw lottery tickets in accordance with various embodiments of the present disclosure. The draw lottery tickets with the collectable symbols can be electronically provided draw lottery tickets in accordance with various other embodiments of the present disclosure.

The additional award opportunities can be a predetermined static award, a randomly determined award, a progressive changing award, or can be an opportunity to win a predetermined static award, a randomly determined award, or a progressive changing award. In various embodiments, the additional award opportunities are not based on any of the player selected numbers for any of the draws of the draw lottery games, are not based on any of the drawn numbers for any of the draws of the draw lottery games, and are thus separate and independent from such numbers.

In various embodiments, the collectable symbols connect the plays (such as multiple drawings) of one or more draw lottery games in one or more different manners and provide additional award opportunities for additional awards in different, separate, and independent manners than the underlying draw lottery games.

In various other embodiments, the additional award opportunities are partly based on or related to the player selected numbers for one or more of the draws of the draw lottery games, and/or are based on or related to the drawn numbers for one or more of the draws of the draw lottery games.

Draw lottery tickets for draw lottery games are employed as example lottery tickets herein; however, it should be appreciated that the present disclosure is not meant to be limited by such examples.

For a better understanding of the present disclosure, an example draw lottery ticket is first described herein. A draw lottery ticket can include: (1) a single set of purchaser numbers for a single play of a draw lottery game; (2) multiple sets of purchaser numbers for a single play of a draw lottery game; (3) a single set of purchaser numbers for each of multiple plays of a draw lottery game; or (4) multiple sets of purchaser numbers for each of multiple plays of a draw lottery game. For simplicity, the present disclosure uses a draw lottery ticket with a single set of purchaser numbers for a single play of a draw lottery game as an example, but it should be appreciated that the present disclosure can be employed for purchasing and redeeming such various other draw lottery tickets.

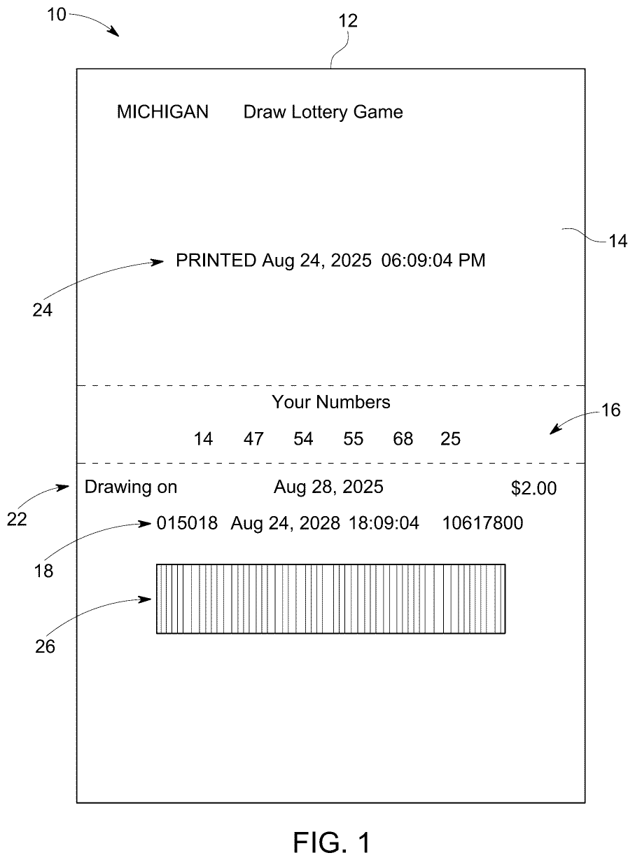

An example physical draw lottery ticket 10 is shown in FIG. 1. This example draw lottery ticket includes: (1) a ticket substrate 12; (2) a front surface 14 of the ticket substrate 12; (3) lottery ticket information, including a single set of purchaser numbers (for a single play of draw lottery game), printed on the front surface 14 of the ticket substrate 12; and (4) a back surface (not shown) of the ticket substrate 12. This example draw lottery ticket 10 is for a single play of a draw lottery game (scheduled to take place on Aug. 28, 2025) and includes a single set of purchaser numbers 16 (i.e., purchaser numbers for the single play of the draw lottery game). The lottery ticket information in this example includes purchaser numbers 16, a ticket identifier 18 that uniquely identifies the lottery ticket 10, a game identifier 20 that identifies the lottery game type, a draw date 22 associated with the ticket 10, and a print date 24 on which the ticket 10 was printed. It should be appreciated that while this draw lottery ticket is for a single play, draw lottery tickets often include multiple sets of purchaser numbers that are for a single play of the draw lottery game. The lottery ticket information can include text, one or more ticket numbers (shown as the ticket identifier 18), one or more ticket barcodes (shown as barcode 26), and other lottery ticket information that is in either or both human readable and machine readable forms. The lottery ticket's barcode 26 is configured to be scanned by a barcode reading device to enable redemption of such draw lottery ticket.

For simplicity, various embodiments of the present disclosure are described in relation to multiple drawings for a single draw lottery game, but it should be appreciated that such descriptions are not meant to limit the present disclosure.

In various embodiments, a draw lottery game can be associated with one or more collectable symbol sets, wherein collectable symbols of the collectable symbol set(s) are printed on the draw lottery tickets for the draw lottery game (such as for a series of drawings of the draw lottery game over a predetermined period of time or such as for a sequential series of drawings of the draw lottery game over a predetermined period of time).

In various embodiments, each collectable symbol set is associated with one or more opportunities for additional awards separate from, independent from, and in addition to the purchaser number sets and the drawn number sets for the drawings of the draw lottery game.

In various embodiments, each lottery collectable symbol set is provided by a lottery gaming system and is configured for a series of drawings of a draw lottery game (such as a series of drawings of the draw lottery game over a predetermined period of time or such as a sequential series of drawings of the draw lottery game over a predetermined period of time).

In various embodiments, each collectable symbol set includes a plurality of collectable symbols, and one or more combinations of the collectable symbols of the collectable symbol set are each winning collectable symbols and each associated with an award opportunity.

In various embodiments, the combination of collectable symbols of the collectable symbol set that is associated with an award opportunity is all of the symbols in the collectable symbol set. For example, if the collectable symbol set includes ten different collectable symbols, then all ten of the collectable symbols must be collected on draw lottery tickets to be a winning collectable symbol combination and thus result in the associated award opportunity.

In various embodiments, the combination of collectable symbols of the collectable symbol set this is associated with an award opportunity and thus a winning collectable symbol combination is less than all of the symbols in the collectable symbol set. For example, if the collectable symbol set includes ten different collectable symbols, then five out of the ten collectable symbols must be collected on draw lottery tickets to obtain the associated award opportunity.

In various embodiments, a collectable symbol set can include only one combination of collectable symbols that is associated with an award opportunity.

In various embodiments, a collectable symbol set can include two or more different combinations of collectable symbols that is associated with an award opportunity.

In various embodiments, different collectable symbol sets can be associated with two or more different draw lottery games.

In various embodiments, the same collectable symbol set can be associated with two or more of the different draw lottery games. In such various embodiment, the collectable symbols on draw lottery tickets from different draw lottery games can be combined to obtain an award opportunity associated with collectable symbol set. In such various embodiment, the collectable symbols on draw lottery tickets from different draw lottery games cannot be combined to obtain an award opportunity associated with collectable symbol set.

In various embodiments, each draw lottery ticket for a draw lottery game includes zero, one, or a plurality of more collectable symbols.

In various embodiments, for each draw lottery ticket for a draw lottery game, the quantity of collectable symbols associated with that draw lottery ticket is predetermined.

In various embodiments, for each draw lottery ticket for a draw lottery game, the quantity of collectable symbols associated with that draw lottery ticket is randomly determined by the lottery system.

In various embodiments, for each draw lottery ticket for a draw lottery game, the quantity of collectable symbols associated with that draw lottery ticket is determined by the lottery system based on one or more factors (such as but not limited to the purchase amount for that draw lottery ticket).

Thus, in various embodiments, only certain draw lottery tickets for a draw lottery game includes one or more collectable symbols of one or more collectable symbol sets. In such embodiments, the lottery system can determine which draw lottery tickets include such collectable symbols from which collectable symbol sets.

In various embodiments, only one set of collectable symbols are associated with a draw lottery game.

In various embodiments, a plurality of sets of collectable symbols are associated with a draw lottery game. In various embodiments, such multiple sets of collectable symbols are different, include different collectable symbols, and/or include different quantities of collected symbols needed to form a combination of collectable symbols of the collectable symbol set that is associated with an award opportunity.

In various embodiments, when a predetermined winning combination of the collectable symbols of a collectable symbol set for a draw lottery game are collected, the lottery gaming system is configured to provide one or more additional award opportunities for the holder of such draw lottery tickets that include the collectable symbols that form the predetermined combination of the collectable symbol set. The additional award opportunities can be a predetermined award, a static award, a randomly determined award, a progressive award, an award in a range of awards, an award in a static range of awards, an award in a changeable range of awards, or another suitable award. In various embodiments, the changeable awards can be progressive awards, pari-mutuel awards, or other suitable changeable awards. In various embodiments, the awards can be static or changeable based on the wager level of the purchased draw lottery tickets.

In various embodiments, the additional award opportunities can be one or more opportunities to win an award (such as one of the awards listed above) such as via the play of a game, via a raffle, or via another suitable mechanism.

The collectable symbols of a collectable symbol set associated with the draw lottery tickets thus provides an additional award feature for a draw lottery game and specifically for multiple drawings of the draw lottery game.

In various embodiments, the lottery gaming system is configured to provide the collectable symbols selected from the collectable symbol set to the purchaser in a physical format such as on the substrate of the draw lottery ticket.

In various embodiments, the lottery gaming system is configured to provide the collectable symbols selected from the collectable symbol set to the purchaser in an electronic format displayable by a display device of a purchaser electronic device (“PED”) used by the purchaser to purchases the draw lottery tickets.

In various such embodiments, the lottery gaming system is configured to provide and enable the display device of the PED to display updated information regarding the collectable symbols, collection of one or more or all of the collectable symbols of a collectable symbol set, and/or any additional award opportunities for collection of such collectable symbols of a collectable symbol set.

In various embodiments, the lottery gaming system is configured to provide all of the collectable symbols free to the purchaser of the draw lottery ticket(s).

In various embodiments, the lottery gaming system is configured to require the purchase of one or more of the collectable symbols on the draw lottery ticket(s).

In various embodiments, the lottery gaming system is configured to provide one or more of the collectable symbols free and to require the purchase of one or more of the collectable symbols. For example, a first draw lottery ticket can include a first quantity such as one or more free collectable symbols and a second quantity such as one or more purchasable collectable symbols.

In various embodiments, the collectable symbol set is configured for a quantity of multiple drawings of a single draw lottery game. In various embodiments, this quantity is limited.

In various embodiments, the collectable symbol set is configured for a quantity of multiple sequential drawings of a single draw lottery game. In various embodiments, this quantity is limited.

In various embodiments, the collectable symbol set is configured for any combination of drawings of a single draw lottery game over a predetermined period of time (such as a month or a year).

In various embodiments, the collectable symbol set is configured for a quantity of multiple drawings of more than one draw lottery game. In various embodiments, this quantity is limited.

In various embodiments, the collectable symbol set is configured for a quantity of multiple sequential drawings of more than one draw lottery game. In various embodiments, this quantity is limited.

In various embodiments, the collectable symbol set is configured for any combination of drawings of more than one draw lottery game (such as during a predetermined period of time).

In various embodiments, the multiple drawings for the draw lottery game can be during a predetermined time period and/or can be for a predetermined quantity of drawings of a draw lottery game. The quantity of drawings that can be employed for can be determined in any suitable manner. In various embodiments, the only the collectable symbols generated and provided on draw lottery tickets during those drawings or during that time period can be employed to complete a combination of collectable symbols (of the respective collectable symbol set) that is associated with an award opportunity.

In various embodiments, the lottery gaming system determines the quantity of collectable sets for the draw lottery game, the quantity of each of the collectable symbols in each of the collectable symbol sets, and the respective quantity of collectable symbols in each collectable symbols set. In various embodiments, based on these determinations, the collection of symbols for multiple collectable symbol sets can overlap.

In various embodiments, the award opportunities can vary based on the quantity of collectable symbols that form the winning combination of collectable symbols for a collectable symbol set. For example, a relatively lower quantity can result in relatively lower value award opportunity for a collectable symbol set and a relatively higher quantity can result in relatively greater value award opportunities.

In various embodiments, the award opportunities can vary based on the purchase amount required for the draw lottery tickets. For example, a relatively lower purchase amount can result in relatively lower value award opportunities for a collectable symbol set and a relatively higher purchase amount can result in relatively greater value award opportunities.

In various embodiments, after a purchaser purchases a draw lottery ticket with one or more collectable symbols, the purchaser is incentivized to purchase additional lottery tickets for the draw lottery game to collect one or more additional collectable symbols.

In various embodiments, after a purchaser purchases a draw lottery ticket with one or more collectable symbols, the lottery gaming system enables the purchaser to enter draw lottery ticket information and/or collectable symbols information into an online portal to enable the purchaser to retain possession digitally of the collectable symbols without needing to keep the physical draw lottery ticket.

In various embodiments, the lottery gaming system enables the purchaser to use the online portal to redeem award if the purchaser completes a predetermined winning combination of the collectable symbols of the collectable symbol set.

In various embodiments, the lottery gaming system provides collectable symbols that are structured as to have relatively small subgroups of winning combinations of collectable symbols to provide a relatively high frequency win rate. These win rate can also be controlled by controlling the distribution of one or more of collectable symbols that are provided at a lower frequency to limit the quantity of awards. The lottery system can increase the quantity of such collectable symbols being provided to provide more awards such as when lottery ticket sales of down or in other situations. The frequency of collection symbol sets being completed can vary based on the award amount and/or one or more other factors. For example, a collectable symbol set associated with a free ticket or a raffle entry can occur with much greater frequency then a collectable symbol set associated with a $10,000 cash award.

FIG. 1 is a flowchart of an example method (indicated by numeral 1000) of operating an example lottery gaming system of the present disclosure. In various embodiments, the method 1000 is represented by a set of instructions stored in one or more memory devices and executed by one or more processors. Although the method 1000 is described with reference to the flowchart shown in FIG. 1, other processes of performing the acts associated with this illustrated example method can be employed. For example, the order of certain of the illustrated blocks and/or diamonds may be changed, certain of the illustrated blocks and/or diamonds may be optional, or certain of the illustrated blocks and/or diamonds may not be employed.

The lottery gaming system determines a collectable symbol set for a draw lottery game, determines the winning collectable symbols for the collectable symbol set, determines the award opportunity for collecting all of the winning collectable symbols of the collectable symbol set, determines the drawings for the draw lottery game associated with the collectable symbol set, and determines any other features and/or requirements associated with draw lottery game, the collectable symbol set, and the winning collectable symbols of the collectable symbol set, as indicated by block 1102.

The lottery gaming system, responsive to a purchaser purchasing a draw lottery ticket for a draw lottery game, generates the draw lottery ticket with zero, one, or a plurality of collectable symbols of the collectable symbol set for that draw lottery ticket, as indicated by block 1104.

In various embodiments, the lottery gaming system enables the purchaser to select the purchaser's numbers for the draw lottery ticket for the drawing for the draw lottery game in any suitable manner. In various embodiments, the determined purchaser numbers for the draw lottery ticket for the drawing of the draw lottery game are directly selected by the purchaser. The determined purchaser numbers for the draw lottery ticket for the drawing of the draw lottery game can also be randomly selected by the lottery gaming system at the request of the purchaser (such as via a quick pick process).

The lottery gaming system, responsive to a purchaser purchasing a lottery ticket for one of the drawings for the draw lottery game, provides the draw lottery ticket to the purchaser with any determined collectable symbols of the collectable symbol set for that draw lottery ticket, as indicated by block 1106. In various embodiments, the lottery game system prints the draw lottery ticket and provides the printed draw lottery ticket to the purchaser. In various embodiments, the lottery game system sends an electronic version of the draw lottery ticket to a purchaser electronic device or purchaser accessible electronic system.

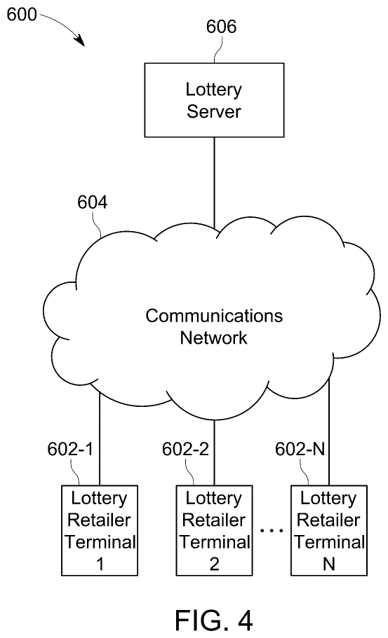

In various embodiments, the lottery gaming system enables the purchaser to purchase the lottery tickets for the drawings of the draw lottery game via any suitable manner such as, but not limited to, one of the following: (1) a dedicated lottery kiosk (e.g., a lottery kiosk) configured to communicate over a data network (such as the Internet) to a lottery server (such as a lottery server 606 described below in connection with FIG. 4); (2) a retailer-operated lottery terminal configured to communicate over a data network (such as the Internet) to a lottery server (such as a lottery server 606 described below in connection with FIG. 4); and/or (3) a PED such as a personal computer configured to communicate over a data network (such as the Internet) to a lottery server (such as a lottery server 606 described below in connection with FIG. 4) or such as a cellular telephone, a tablet, a smart phone, or other suitable device configured to communicate over a data network (such as a wireless or cellular data network) to a lottery server (such as a lottery server 606 described below in connection with FIG. 4). In one such example embodiment, the lottery gaming system enables a purchaser to use a paper playslip to purchase a draw lottery ticket at a retail location having a lottery terminal configured to receive the playslip and print the draw lottery ticket at the time of purchase in a conventional manner. In such lottery gaming systems, the retail operator can receive the purchase price for the lottery ticket from the purchaser in a conventional manner. In another such example embodiment, the lottery gaming system enables a purchaser to use a virtual playslip to purchase a draw lottery ticket through a retail lottery kiosk configured to display the playslip (as further described below), receive the purchaser number selections using the displayed playslip (as further described below), receive the wager from the purchaser, and print the draw lottery ticket at the time of purchase. This example lottery kiosk may include an integral printer device and/or be in communication with a printer device for providing a printed draw lottery ticket to the purchaser. In another such example embodiment, the lottery gaming system enables a purchaser to use a virtual playslip to purchase a draw lottery ticket electronically using a PED. In one such embodiment, the lottery gaming system receives from this device the purchaser number selections and the wager from the purchaser, and sends the purchaser an electronic draw lottery ticket (which in certain instances can be printed by the purchaser using a suitable personal printing device). Thus, it should be appreciated that in various example embodiments, the purchaser may purchase a lottery ticket with a PED, and thus, may not be provided with a physical (i.e., paper) lottery ticket. Instead, an electronic (or virtual) version of the lottery ticket is provided to the purchaser via, for example, an electronic mail to an email account associated with the purchaser.

The lottery gaming system stores data associated with the draw lottery ticket, the numbers of the draw lottery ticket, and each of the collectable symbols on the draw lottery ticket, as indicated by block 1108.

In various embodiments, for each lottery ticket purchased, the lottery gaming system creates a data record corresponding to that lottery ticket. For example, when a lottery terminal is used to purchase a lottery ticket, the lottery gaming system creates a data record including suitable information such as but not limited to: (1) a timestamp (date and/or time) associated with when the lottery ticket was purchased; (2) an identification number for the lottery ticket; (3) the purchaser-selected wager amount for the drawing of the draw lottery game; (4) the lottery ticket identification number; (5) any collectable symbols on the lottery ticket; and (6) any other suitable information. In various embodiments, this data record is created by the lottery terminal and sent by the lottery terminal to the lottery server (such as described below in connection with the lottery server 606 of FIG. 4). It should be appreciated that the lottery ticket data record can be otherwise suitably created in accordance with the present disclosure.

The lottery gaming system at the time of the drawing for the draw lottery game randomly determines drawn lottery numbers for the drawing of the draw lottery game, as indicated by block 1110.

The lottery gaming system determines any awards for the drawing of the draw lottery game based on the drawn numbers, as indicated by block 1112. In various embodiments, this determination includes a determination of any awards for the drawing of the draw lottery game based on the quantity of matches between the purchaser numbers and the drawn lottery numbers for that drawing of the draw lottery game.

The lottery gaming system enables the purchaser of multiple draw lottery tickets (that include all the winning collectable symbols needed for a collectable symbol set to win an award opportunity) to redeem those draw lottery tickets for the additional award opportunity, as indicated by block 1114.

In various such embodiments, where a draw lottery ticket is a winning lottery ticket based on drawn numbers and includes one or more collectable symbols, the redemption process can include enabling the purchaser of the winning draw lottery ticket to maintain such draw lottery ticket after redemption to keep such collectable symbols. In various embodiments, such a draw lottery ticket can be physically marked as redeemed.

In various such embodiments, where a draw lottery ticket is a winning lottery ticket based on drawn numbers and includes one or more collectable symbols, the redemption process can require the purchaser of the winning draw lottery ticket to release the draw lottery ticket as part of the redemption process, and thus to give up the collectable symbols on that draw lottery ticket.

In various such embodiments, where a draw lottery ticket is a winning lottery ticket based on drawn numbers and includes one or more collectable symbols, the purchaser of the winning draw lottery ticket can hold onto and not redeem the winning draw lottery ticket until the time period for collecting collectable symbols on that draw lottery ticket has expired.

It should be appreciated that the period of time for each collectable symbol set can be limited to address this issue. For example, only draw lottery tickets for the drawings of a draw lottery game in a single month can be combined with respect to the collectable symbols on such draw lottery tickets.

In various embodiments, the lottery gaming system enables a purchaser of a draw lottery ticket to trade, transfer, exchange, and/or sell one or more of their draw lottery tickets.

In various embodiments, the lottery gaming system enables a subsequent purchaser to purchase a draw lottery ticket from an initial or previous purchaser of the draw lottery ticket.

In various embodiments, the lottery gaming system enables the purchaser to cash in one or more draw lottery tickets.

It should be appreciated that the term purchaser is used herein to include the original purchaser of the draw lottery ticket and any subsequent purchaser or receiver or holder of that draw lottery ticket.

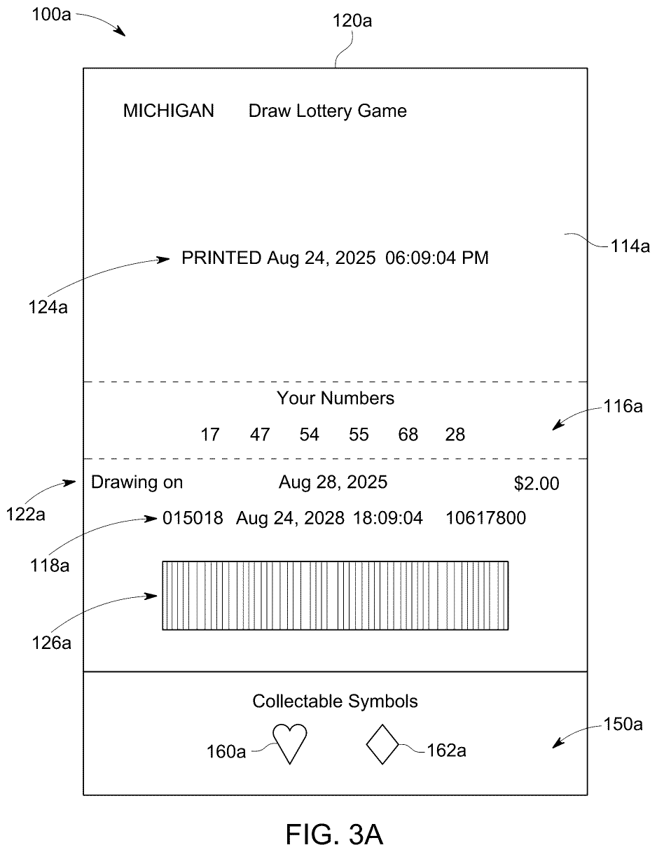

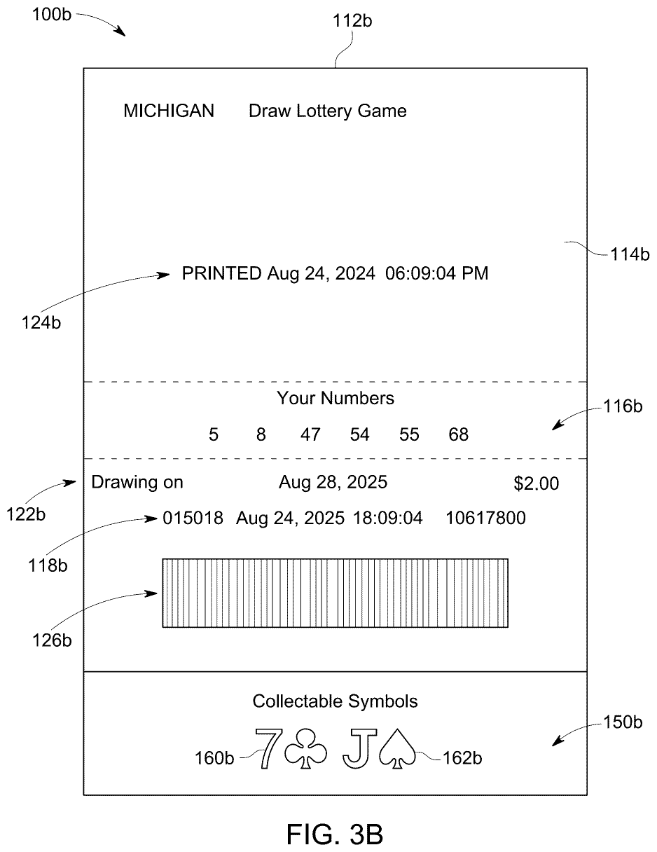

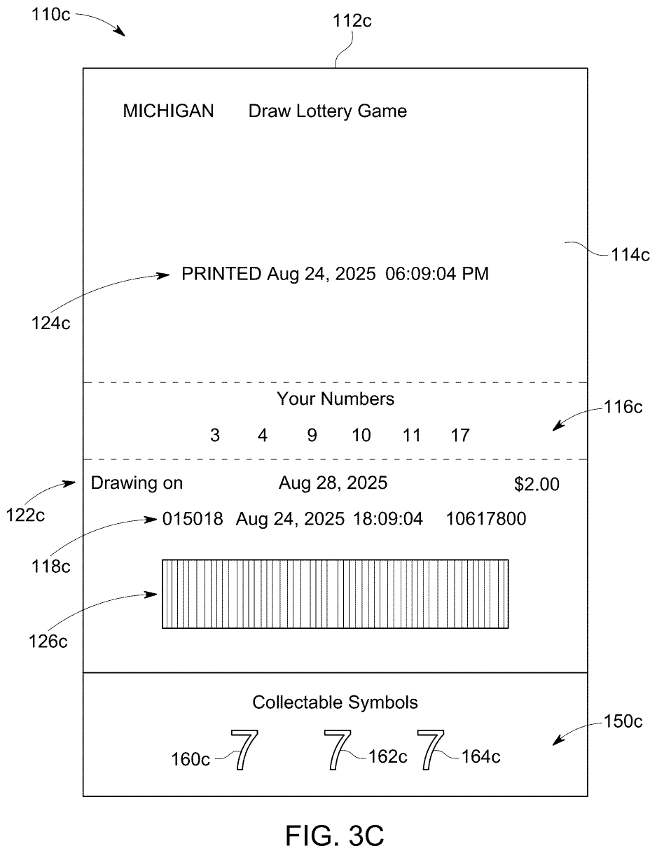

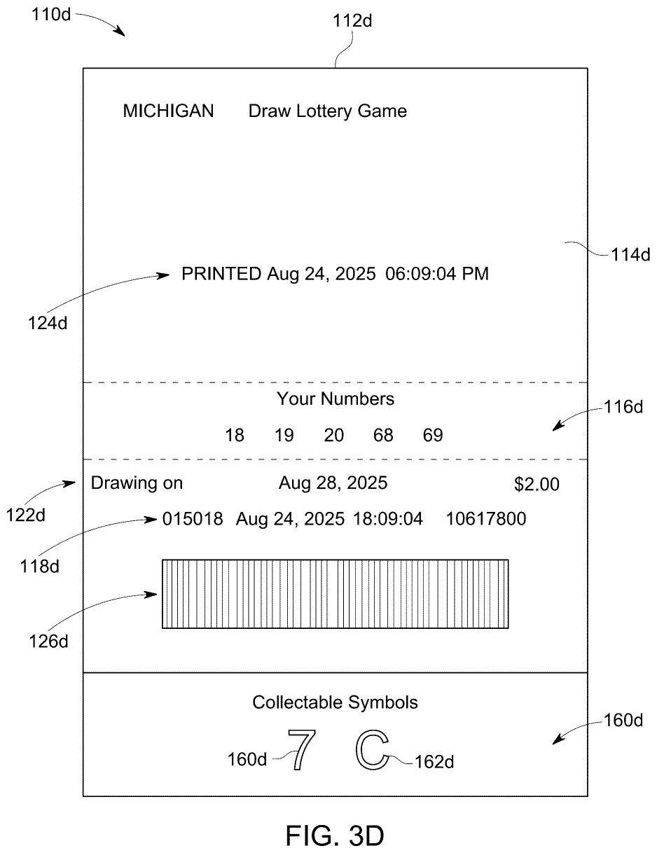

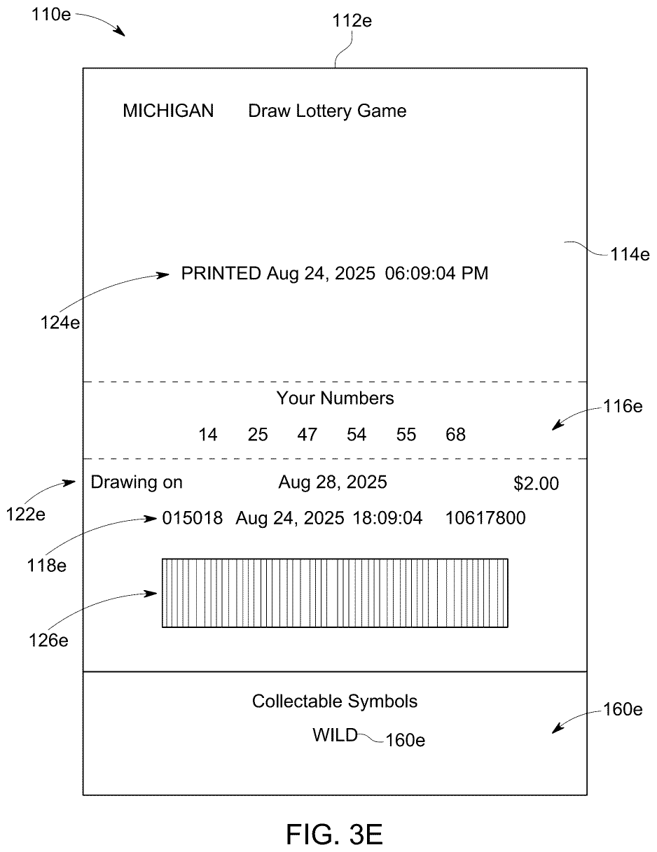

FIGS. 3A, 3B, 3C, 3D, and 3E show examples of different draw lottery tickets in accordance with the present disclosure.

More specifically, FIG. 3A shows an example physical draw lottery ticket 100a. This example draw lottery ticket 100a includes: (1) a ticket substrate 120a; (2) a front surface 114a of the ticket substrate 120a; (3) lottery ticket information, including a single set of purchaser numbers (for a single play of draw lottery game), printed on the front surface 114b of the ticket substrate 120a; and (4) a back surface (not shown) of the ticket substrate 120a. This example draw lottery ticket 100a is for a single play of a draw lottery game (scheduled to take place on Aug. 28, 2025) and includes a single set of purchaser numbers 116a (i.e., purchaser numbers for the single play of the draw lottery game). The lottery ticket information in this example includes purchaser numbers 116a, a ticket identifier 118a that uniquely identifies the lottery ticket 100a, a game identifier 122a that identifies the lottery game type, a draw date associated with the draw lottery ticket 100a, and a print date on which the draw lottery ticket 100a was printed. The lottery ticket information can include text, one or more ticket numbers (shown as the ticket identifier 118a), one or more ticket barcodes (shown as barcode 126a), and other lottery ticket information that is in either or both human readable and machine readable forms. The lottery ticket's barcode 126a is configured to be scanned by a barcode reading device to enable redemption of such draw lottery ticket.

The physical draw lottery ticket 100a further includes a collectable symbols area 150a and two collectable symbols 160a and 162a in the collectable symbols area 150a. These two collectable symbols 160a and 162a are from the same collectable symbol set that in this example includes the heart, diamond, club, and spade collectable symbols. In this example, the collectable symbol set structure is configured with only four symbols that need to be collected to obtain the award opportunity. While the award opportunity may be relatively low or result in a low award, it can be frequently awarded. This provides the purchasers with incentives to purchase draw lottery tickets. In various such embodiments, while there is a relatively low quantity of collectable symbols needed to obtain the award opportunity, one or more of these collectable symbols can have a low probability of being generated on a draw lottery ticket, and thus the award opportunity can have a greater value.

FIG. 3B shows an example physical draw lottery ticket 100b is shown in FIG. 1. This example draw lottery ticket includes: (1) a ticket substrate 120b; (2) a front surface 114b of the ticket substrate 120b; (3) lottery ticket information, including a single set of purchaser numbers (for a single play of draw lottery game), printed on the front surface 114b of the ticket substrate 120b; and (4) a back surface (not shown) of the ticket substrate 120b. This example draw lottery ticket 100b is for a single play of a draw lottery game (scheduled to take place on Aug. 28, 2025) and includes a single set of purchaser numbers 116b (i.e., purchaser numbers for the single play of the draw lottery game). The lottery ticket information in this example includes purchaser numbers 116b, a ticket identifier 118a that uniquely identifies the lottery ticket 100b, a game identifier 122b that identifies the lottery game type, a draw date associated with the draw lottery ticket 100b, and a print date on which the draw lottery ticket 100b was printed. The lottery ticket information can include text, one or more ticket numbers (shown as the ticket identifier 118b), one or more ticket barcodes (shown as barcode 126b), and other lottery ticket information that is in either or both human readable and machine readable forms. The lottery ticket's barcode 126b is configured to be scanned by a barcode reading device to enable redemption of such draw lottery ticket.

The physical draw lottery ticket 100b further includes a collectable symbols area 150b and two collectable symbols 160b and 162b in the collectable symbols area 150b.

These two collectable symbols 160b and 162b are from the same collectable symbol set that in this example includes 52 collectable symbols (corresponding to the symbols of a deck of cards). In this example, the collectable symbol set structure is configured with a greater quantity of collectable symbols that can be collected. In various embodiments, the collectable symbols of the collectable symbol set that are associated with an award opportunity can be any suitable combinations-such as winning poker combinations or winning blackjack combinations. Such as structure can be easy for a purchaser to understand.

FIG. 3C shows an example physical draw lottery ticket 100c. This example draw lottery ticket 100c includes: (1) a ticket substrate 120c; (2) a front surface 114c of the ticket substrate 120c; (3) lottery ticket information, including a single set of purchaser numbers (for a single play of draw lottery game), printed on the front surface 114c of the ticket substrate 120c; and (4) a back surface (not shown) of the ticket substrate 120c. This example draw lottery ticket 100c is for a single play of a draw lottery game (scheduled to take place on Aug. 28, 2025) and includes a single set of purchaser numbers 116c (i.e., purchaser numbers for the single play of the draw lottery game). The lottery ticket information in this example includes purchaser numbers 116c, a ticket identifier 118c that uniquely identifies the lottery ticket 100c, a game identifier 122c that identifies the lottery game type, a draw date associated with the draw lottery ticket 100c, and a print date on which the draw lottery ticket 100c was printed. The lottery ticket information can include text, one or more ticket numbers (shown as the ticket identifier 118c), one or more ticket barcodes (shown as barcode 126c), and other lottery ticket information that is in either or both human readable and machine readable forms. The lottery ticket's barcode 126c is configured to be scanned by a barcode reading device to enable redemption of such draw lottery ticket.

The physical draw lottery ticket 100c further includes a collectable symbols area 150c and three collectable symbols 160c, 162c, and 164c in the collectable symbols area 150c. In this example, the three 7 collectable symbols 160c, 162c, and 164c are from the same collectable symbol set and by themselves from a winning collectable symbol combination. This example thus shows that in certain embodiments, a single draw lottery ticket can result in an award opportunity.

FIG. 3D shows an example physical draw lottery ticket 100d. This example draw lottery ticket 100d includes: (1) a ticket substrate 120d; (2) a front surface 114d of the ticket substrate 120d; (3) lottery ticket information, including a single set of purchaser numbers (for a single play of draw lottery game), printed on the front surface 114d of the ticket substrate 120d; and (4) a back surface (not shown) of the ticket substrate 120d. This example draw lottery ticket 100d is for a single play of a draw lottery game (scheduled to take place on Aug. 28, 2025) and includes a single set of purchaser numbers 116d (i.e., purchaser numbers for the single play of the draw lottery game). The lottery ticket information in this example includes purchaser numbers 116d, a ticket identifier 118d that uniquely identifies the lottery ticket 100d, a game identifier 122d that identifies the lottery game type, a draw date associated with the draw lottery ticket 100d, and a print date on which the draw lottery ticket 100d was printed. The lottery ticket information can include text, one or more ticket numbers (shown as the ticket identifier 118d), one or more ticket barcodes (shown as barcode 126d), and other lottery ticket information that is in either or both human readable and machine readable forms. The lottery ticket's barcode 126d is configured to be scanned by a barcode reading device to enable redemption of such draw lottery ticket.

The physical draw lottery ticket 100d further includes a collectable symbols area 150d and two collectable symbols 160d and 162d in the collectable symbols area 150d. In this example, the collectable symbol 160d and the collectable symbol 162d are from separate collectable symbol sets, and thus unrelated and cannot be used together to obtain an award opportunity.

FIG. 3E shows an example physical draw lottery ticket 100e. This example draw lottery ticket 100e includes: (1) a ticket substrate 120e; (2) a front surface 114e of the ticket substrate 120e; (3) lottery ticket information, including a single set of purchaser numbers (for a single play of draw lottery game), printed on the front surface 114e of the ticket substrate 120e; and (4) a back surface (not shown) of the ticket substrate 120e. This example draw lottery ticket 100e is for a single play of a draw lottery game (scheduled to take place on Aug, 28, 2025) and includes a single set of purchaser numbers 116e (i.e., purchaser numbers for the single play of the draw lottery game). The lottery ticket information in this example includes purchaser numbers 116e, a ticket identifier 118e that uniquely identifies the lottery ticket 100e, a game identifier 122e that identifies the lottery game type, a draw date associated with the draw lottery ticket 100e, and a print date on which the draw lottery ticket 100e was printed. The lottery ticket information can include text, one or more ticket numbers (shown as the ticket identifier 118e), one or more ticket barcodes (shown as barcode 126e), and other lottery ticket information that is in either or both human readable and machine readable forms. The lottery ticket's barcode 126e is configured to be scanned by a barcode reading device to enable redemption of such draw lottery ticket.

The physical draw lottery ticket 100e further includes a collectable symbols area 150e and a collectable symbols that is a wild symbol 160e in the collectable symbols area 150e. This wild symbol can function as any of the collectable symbols of a winning combination of collectable symbols for a collectable symbol set. This example shows that collectable symbols of a collectable symbol set can have additional features. In various embodiments, if more than one collectable symbol set are associated with the draw lottery ticket, the wild symbol can be used with either set, and the purchaser may have to make a choice as to which collectable symbol set to use the wild symbol with.

It should be appreciated from the above that various embodiments of the present disclosure provide a lottery gaming system including a lottery terminal and associated draw lottery ticket printer, and a central lottery server configured to: (1) associate a draw lottery game with a collectable symbol set, the collectable symbol set comprising collectable symbols and associated with a winning combination of the collectable symbols; (2) thereafter, enable purchases of draw lottery tickets for each of a plurality of drawings of the draw lottery game, (a) wherein each of the draw lottery tickets comprises purchaser numbers for at least one of the plurality of drawings of the draw lottery game, and (b) wherein each of the draw lottery tickets comprises a quantity of the collectable symbols of the collectable symbol set, the quantity being at least one; (3) cause the lottery terminal and the draw lottery ticket printer to co-act to, for each of the draw lottery tickets, print the draw lottery ticket with the purchaser numbers and the collectable symbols of that draw lottery ticket; (4) for each of the plurality of drawings of the draw lottery game: (i) cause an indication of randomly determined drawn symbols for that drawing of the draw lottery game, and (ii) cause a determination of any award amounts based on the drawn symbols for that drawing of the draw lottery game; and (5) enable redemption of a quantity of the draw lottery tickets that comprise collectable symbols that form the winning collectable symbol combination associated with the collectable symbol set.

In various such embodiments, the lottery gaming system is further configured to, for each of the draw lottery tickets, randomly determine the quantity of collectable symbols for that draw lottery ticket.

In various such embodiments, the lottery gaming system is further configured to, for each of the draw lottery tickets, determine the quantity of collectable symbols for that draw lottery ticket based on a purchase amount for the draw lottery ticket.

In various such embodiments, the lottery gaming system is further configured to, for each of the draw lottery tickets, determine the quantity of collectable symbols for that draw lottery ticket based on a quantity of the drawings of the draw lottery game the draw lottery ticket is for.

In various such embodiments, the lottery gaming system is further configured to, for each of the draw lottery tickets, randomly determine the quantity of collectable symbols for that draw lottery ticket and the collectable symbols of the collectable symbol set for that draw lottery ticket.

In various such embodiments, the lottery gaming system is further configured to, for each of the draw lottery tickets, randomly determine the collectable symbols of the collectable symbol set for that draw lottery ticket.

In various such embodiments, the lottery gaming system is further configured to enable redemption of the quantity of the draw lottery tickets that comprise collectable symbols that form the winning combination, wherein the draw lottery tickets are from a pre-determined quantity of the drawings for the draw lottery game.

In various such embodiments, the lottery gaming system is further configured to enable redemption of the quantity of the draw lottery tickets that comprise collectable symbols that form the winning combination, wherein the draw lottery tickets are from a quantity of sequential drawings of the drawings for the draw lottery game.

In various such embodiments, the lottery gaming system is further configured to enable redemption of the quantity of the draw lottery tickets that comprise collectable symbols that form the winning combination, wherein the draw lottery tickets are from a plurality of the drawings for the draw lottery game during a predetermined time period.

In various such embodiments, for one of the draw lottery tickets, the quantity of the collectable symbols of the collectable symbol set for that draw lottery ticket are the collectable symbols of the winning combination.

It should be appreciated from the above that various other embodiments of the present disclosure provide a lottery gaming system including a lottery terminal and associated draw lottery ticket printer, and a central lottery server configured to: (1) associate a draw lottery game with a collectable symbol set, the collectable symbol set comprising different collectable symbols and associated with a winning combination of the different collectable symbols; (2) thereafter, enable purchases of draw lottery tickets for each of a plurality of drawings of the draw lottery game, (a) wherein each of the draw lottery tickets comprises purchaser numbers for at least one of the plurality of drawings of the draw lottery game, (b) wherein each of the draw lottery tickets comprises one of: (i) a first quantity of the collectable symbols of the collectable symbol set, wherein the first quantity is zero, (ii) a second quantity of the collectable symbols of the collectable symbol set, wherein the second quantity is one, and (iii) a third quantity of the collectable symbols of the collectable symbol set, wherein the third quantity is more than one; (3) cause the lottery terminal and the draw lottery ticket printer to co-act to, for each of the draw lottery tickets, print the draw lottery ticket with the purchaser numbers and the collectable symbols of that draw lottery ticket; (4) for each of the plurality of drawings of the draw lottery game: (a) cause an indication of randomly determined drawn symbols for that drawing of the draw lottery game, and (b) cause a determination of any award amounts based on the drawn symbols for that drawing of the draw lottery game; and (5) enable redemption of a quantity of the draw lottery tickets that comprise collectable symbols that form the winning collectable symbol combination associated with the collectable symbol set.

In various such embodiments, the lottery gaming system is further configured to, for each of the draw lottery tickets of the first group of draw lottery tickets, the second group of draw lottery tickets, and the group of draw lottery tickets, randomly determine the quantity of collectable symbols for that draw lottery ticket.

In various such embodiments, the lottery gaming system is further configured to, for each of the draw lottery tickets of the second group of draw lottery tickets and the third group of draw lottery tickets, determine the quantity of collectable symbols for that draw lottery ticket based on a purchase amount for the draw lottery ticket.

In various such embodiments, the lottery gaming system is further configured to, for each of the draw lottery tickets of the first group of draw lottery tickets and the second group of draw lottery tickets, determine the quantity of collectable symbols for that draw lottery ticket based on a quantity of the drawings of the draw lottery game the draw lottery ticket comprises.

In various such embodiments, the lottery gaming system is further configured to, for each of the draw lottery tickets of the second group of draw lottery tickets and the third group of draw lottery tickets, randomly determine the collectable symbols for that draw lottery ticket.

It should be appreciated from the above that various embodiments of the present disclosure provide a lottery gaming system including a lottery terminal and associated draw lottery ticket printer, and a central lottery server configured to: (1) associate a draw lottery game with a first collectable symbol set, the first collectable symbol set comprising first collectable symbols and associated with a first winning combination of the first collectable symbols; (2) associate a draw lottery game with a second collectable symbol set, the section collectable symbol set comprising second collectable symbols and associated with a second winning combination of the second collectable symbols; (3) thereafter, enable purchases of draw lottery tickets for each of a plurality of drawings of the draw lottery game, (a) wherein each of the draw lottery tickets comprises purchaser numbers for at least one of the plurality of drawings of the draw lottery game, (b) wherein each of the draw lottery tickets comprises a first quantity of the first collectable symbols of the first collectable symbol set, (c) wherein each of the draw lottery tickets comprises a second quantity of the second collectable symbols of the second collectable symbol set, and (d) wherein one of the first quantity and the second quantity is at least one; (4) cause the lottery terminal and the draw lottery ticket printer to co-act to, for each of the draw lottery tickets, print the draw lottery ticket with the purchaser numbers and any of the first collectable symbols and the second collectable symbols of that draw lottery ticket; (5) for each of the plurality of drawings of the draw lottery game:
(a) cause an indication of randomly determined drawn symbols for that drawing of the draw lottery game, and (b) cause a determination of any award amounts based on the drawn symbols for that drawing of the draw lottery game; and (6) enable redemption of a quantity of the draw lottery tickets that comprise either the first collectable symbols that form the first winning collectable symbol combination associated with the first collectable symbol set or the second collectable symbols that form the second winning collectable symbol combination associated with the second collectable symbol set.

In various such embodiments, the lottery gaming system is further configured to, for each of the draw lottery tickets, randomly determine the quantity of first collectable symbols and the quantity of second collectable symbols for that draw lottery ticket.

In various such embodiments, the first quantity is at least one and the second quantity is at least one.

In various such embodiments, the lottery gaming system is further configured to, for each of the draw lottery tickets, determine the quantity of the first collectable symbols and the quantity of the second collectable symbols for that draw lottery ticket based on a quantity of the drawings of the draw lottery game the draw lottery ticket comprises.

In various such embodiments, the lottery gaming system is further configured to, for each of the draw lottery tickets, randomly determine which of the first and second collectable symbols of the collectable symbol sets to employ for determining collectable symbols for that draw lottery ticket.

It should be appreciated from the above that the present disclosure improves lottery gaming technology in part by providing: (1) new ways to connect different drawings of draw lottery games; (2) new ways for purchasers to interact with lottery gaming systems; (3) new ways to win award opportunities that are based on multiple single drawings for a draw lottery game; (4) new ways to win awards that are based on multiple drawings of a draw lottery game; and (5) new draw lottery ticket features for drawings of a draw lottery game.

### Example Lottery Gaming Systems—General

As mentioned above, in various embodiments, the lottery gaming system of the present disclosure is configured to be operated by a lottery agency (such as a state lottery agency).

As mentioned above, in various other embodiments, the lottery gaming system of the present disclosure is configured to be operated by a third party that runs the lottery for a lottery agency (such as a state lottery agency).

FIG. 4 illustrates an example networked lottery gaming system 600 for such implementation. This example network lottery gaming system 600 generally includes: (1) a plurality of lottery retailer terminals 602-1 to 602-N; (2) a communications network 604; and (3) one or more lottery servers such as lottery server 606. Generally, the retailer terminals 602-1 to 602-N and the lottery server 606 are configured to perform the functions described above and further described below.

In this example embodiment, each retailer terminal 602 corresponds to (or is associated with) a particular lottery retailer. For example, the first retailer terminal 602-1 of FIG. 4 may be associated with a first lottery retailer, such as a convenience store, and the second retailer terminal 602-2 of FIG. 4 may be associated with a second lottery retailer, such as a supermarket. It should be understood that any suitable quantity of lottery retailer terminals may be employed in the lottery gaming system 600, along with any suitable quantity of corresponding lottery servers 606.

In various example embodiments, the lottery retailer terminal 602 includes one or more processor(s). Generally, the processor is operative to perform or process instructions, and in particular, to operate in accordance with the various methods described herein. For example, the processor of the lottery retailer terminal 602 may be operable to enable the lottery retailer terminal 602 to transmit data to (and receive data from) the lottery server 606. More specifically, the processor may enable the transmission of data representing each lottery ticket.

In various example embodiments, the lottery retailer terminal 602 includes one or more input device(s). The input devices of the lottery retailer terminal 602 may include components such as an optical scanner and/or a barcode scanner, for reading and/or for deriving information associated with a playslip and/or a lottery ticket. For example, a lottery ticket may include registration marks, authenticity data, various codes, micro-printed indicia, one or more sense marks, and/or other lottery indicia that must be read. Examples of additional input devices include, but are not limited to, a keypad, a mouse, an image capturing device (e.g., an optical character recognition (OCR) device), a biometric reader, a portable storage device (e.g., a memory stick), and the like.

In various example embodiments, the input device(s) of the lottery retailer terminal 602 may include a clock. The clock may be employed to detect, derive and/or append time and/or date information for use by the lottery server 606 to: (i) create a data record corresponding to lottery tickets purchased at the lottery retailer terminal 602, (ii) to determine redemption time, round and/or date information associated with lottery tickets, and/or (iii) determine whether a lottery purchaser has redeemed their lottery ticket in a manner that qualifies the purchaser to receive a particular redemption or settlement amount.

In various example embodiments, the lottery retailer terminal 602 includes one or more output device(s). Such output device(s) may include such components as a display for outputting information to a lottery purchaser or to a terminal operator (e.g., win/loss information and/or payout amounts), one or more benefit output devices (e.g., a cash drawer, a currency dispenser), a printer for producing a physical record (e.g., paper slip, receipt, ticket, voucher, coupon, etc.) that defines a lottery ticket, audio/video output device(s), and the like.

In various example embodiments, the lottery retailer terminal 602 also includes one or more communications port(s), such as a serial port, a modem or the like. Generally, the communications port of the lottery retailer terminal 602 may be operable to facilitate two-way data communications between (i) the lottery retailer terminal 602, and (ii) the lottery server 606. In accordance with some embodiments, the communications port of the lottery retailer terminal 602 may operate to facilitate the transmission of information between the lottery retailer terminal and a purchaser device such as a personal digital assistant (PDA), cell phone and/or a dedicated (e.g., a proprietary) device.

In various example embodiments, the lottery retailer terminal 602 includes a data storage device such as a hard disk, optical or magnetic media, random access memory (RAM) and/or read-only memory (ROM), or the like memory device. Generally, the data storage device of the lottery retailer terminal 602 stores a software program, the software program enabling a processor of the retailer terminal 602 to perform various functions including some or all of the various steps described herein. For example, in accordance with various embodiments, the lottery retailer terminal 602 may be configured to perform some or all of the functions of the lottery server 606 (and vice versa) such that the lottery server 606 and the lottery retailer terminal 602 may be considered as the same “device.”

In various example embodiments, a lottery sales device may be utilized in place of a lottery retailer terminal 602. Such a lottery sales device may be implemented as a lottery server, a controller, a dedicated hardware circuit, an appropriately programmed general-purpose computer, or any other equivalent electronic, mechanical or electro-mechanical device. Thus, in various embodiments, a lottery sales device may include, for example, but is not limited to: (1) a video lottery terminal that may include a touch sensitive screen for use by a purchaser; (2) a personal computer (e.g., which communicates with a remote lottery server); or (3) a personal mobile device such as a mobile telephone, a tablet, or a personal digital assistant. The lottery sales device may include any or all of the devices of the aforementioned systems.

In this example embodiment, the lottery server 606 operates to: (1) receive and/or store data associated with one or more lottery tickets including such data as: (a) ticket identifier(s), and (b) ticket indicia; (2) determine at least a first redemption amount associated with a lottery ticket; (3) receive a redemption request associated with the lottery ticket; (4) determine a time of play associated with the redemption request; and (5) transmit an indication of the appropriate redemption amount to a lottery retailer terminal (e.g., for output or display to a lottery purchaser and/or lottery terminal operator).

In various example embodiments, the lottery server 606 includes one or more processor(s). Such a processor functions to process instructions, and in particular, to operate in accordance with various methods described herein. For example, the processor may operate to enable the lottery server 606 to transmit data to (and receive data from) the lottery retailer terminal 602. More specifically, the processor of the lottery server 606 may enable the transmission of data representing a lottery ticket, as well as information defining one or more payout(s) associated with that lottery ticket to or by a specific one of the lottery retailer terminals 602 shown in the lottery network 600 of FIG. 4. Thus, the lottery server 606 may be implemented as a system controller, a dedicated hardware circuit, an appropriately and particularly programmed general-purpose computer, or any other equivalent electronic, mechanical or electro-mechanical device capable of providing for one or more of the embodiments described herein.

In various example embodiments, the lottery server 606 includes one or more input device(s). Examples of such input devices include a keypad, a mouse, a touch-screen, a random number generator, a microphone, and other digital or analog input devices.

In various example embodiments, the lottery server 606 also includes one or more output device(s). Example of output device(s) of the lottery server 606 include a monitor or other display for outputting information to an operator of the lottery server 606 (e.g., for displaying information such as statistical or sales data, win and loss information and/or payout amounts), a printer for producing a physical record (e.g., a report) of such data, and the like. In addition, the lottery server 606 may include one or more communications ports, such as a serial port, modem or the like, operable to facilitate two-way data communications between (i) the lottery server 606 and (ii) one or more lottery retailer terminals 602.

In various example embodiments, the lottery server 606 includes a data storage device (e.g., a hard disk or hard drive, a media-based (removable) memory, or the like). In certain embodiments, the data storage device of the lottery server 606 stores at least one software program, which includes a program to enable the processor of the lottery server 606 to perform some or all of the various steps and functions of at least one implementation of the methods described in detail herein. In addition, the data storage device of the lottery server 606 may operate to store one or more databases including a lottery ticket database and a lottery ticket redemption status database.

In various example embodiments, the lottery server 606 includes a lottery ticket server device that is located at a lottery ticket printing facility, and may also function to manage the ticket printing process. The lottery server 606 may also function to develop a lottery game matrix (e.g., determining base payouts, win frequencies, and the like) and to match static lottery content with secure paytable (or payout distribution) data. In certain embodiments, a lottery ticket printer device for use in such lottery gaming systems may utilize the game matrix information from the lottery server and may apply it to the secure paytable data.

In certain example embodiments, a retailer terminal (such as the first retailer terminal 602-1) of FIG. 4 is configured to perform some or all of the functions of the lottery server 606. Thus, in certain example embodiments, the lottery server 606 and the retailer terminal (such as the first retailer terminal 602-1) (or another given retailer terminal and server pairing) may be considered as the same “device.”

Generally, the communications network 604 of FIG. 4 includes one or more local and/or wide-area network(s) proprietary and/or public network(s) (e.g., the Internet) for facilitating two-way data communications between the retailer terminals 602 and the lottery server 606. The lottery server 606 may communicate with lottery retailer terminals 602 directly or indirectly, via a wired or wireless medium, such as via the Internet, via a local area network (LAN), via a wide area network (WAN), via an Ethernet, via a Token Ring, via a telephone line, via a cable line, via a radio channel, via an optical communications line, via a satellite communications link, or via any other appropriate communications system or combinations thereof. Any number and type of devices may be in communication with the lottery server 606, and communication between the lottery retailer terminals 602 and the lottery server 606 may be direct or indirect. A variety of communications protocols may be part of any such communications system, including, but not limited to: Ethernet (or IEEE 802.3), SAP, ATP, Bluetooth™, and TCP/IP.

It should be understood that devices in communication with each other need not be continually transmitting to each other. On the contrary, such devices need only transmit to each other as necessary, and may actually refrain from exchanging data most of the time. For example, a device in communication with another device via the Internet may not transmit data to the other device for days or weeks at a time. In some embodiments, a server may not be necessary and/or preferred. For example, in one or more embodiments, methods described herein may be practiced on a stand-alone gaming device and/or a gaming device in communication only with one or more other gaming devices. In such an embodiment, any functions described as performed by the computer may instead be performed by one or more gaming devices.

As used herein, a lottery retailer may include a merchant who sells lottery tickets at a particular location, authenticates winning lottery tickets, redeems authenticated winning lottery tickets, and/or provides awards to purchasers for winning lottery tickets. Examples of various lottery retailers include, but are not limited to, convenience stores, gas stations, supermarkets, and gaming establishments.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

The claims are as follows:

1. A lottery gaming system comprising:
a lottery terminal and associated draw lottery ticket printer; and
a central lottery server comprising a processor and a memory device that stores a plurality of instructions, that when executed by the processor, cause the processor to:
associate a draw lottery game with a collectable symbol set, the collectable symbol set comprising collectable symbols and associated with a winning combination of the collectable symbols;
thereafter, enable purchases of draw lottery tickets for each of a plurality of drawings of the draw lottery game,
wherein each of the draw lottery tickets comprises purchaser numbers for at least one of the plurality of drawings of the draw lottery game,
wherein each of the draw lottery tickets comprises a quantity of the collectable symbols of the collectable symbol set, the quantity being at least one;
cause the lottery terminal and the draw lottery ticket printer to co-act to, for each of the draw lottery tickets, print the draw lottery ticket with the purchaser numbers and the collectable symbols of that draw lottery ticket;
for each of the plurality of drawings of the draw lottery game:
cause an indication of randomly determined drawn symbols for that drawing of the draw lottery game, and
cause a determination of any award amounts based on the drawn symbols for that drawing of the draw lottery game; and
enable redemption of a quantity of the draw lottery tickets that comprise collectable symbols that form the winning collectable symbol combination associated with the collectable symbol set.

2. The lottery gaming system of claim 1, wherein the plurality of instructions, when executed by the processor, cause the processor to, for each of the draw lottery tickets, randomly determine the quantity of collectable symbols for that draw lottery ticket.

3. The lottery gaming system of claim 1, wherein the plurality of instructions, when executed by the processor, cause the processor to, for each of the draw lottery tickets, determine the quantity of collectable symbols for that draw lottery ticket based on a purchase amount for the draw lottery ticket.

4. The lottery gaming system of claim 1, wherein the plurality of instructions, when executed by the processor, cause the processor to, for each of the draw lottery tickets, determine the quantity of collectable symbols for that draw lottery ticket based on a quantity of the drawings of the draw lottery game the draw lottery ticket is for.

5. The lottery gaming system of claim 1, wherein the plurality of instructions, when executed by the processor, cause the processor to, for each of the draw lottery tickets, randomly determine the quantity of collectable symbols for that draw lottery ticket and the collectable symbols of the collectable symbol set for that draw lottery ticket.

6. The lottery gaming system of claim 1, wherein the plurality of instructions, when executed by the processor, cause the processor to, for each of the draw lottery tickets, randomly determine the collectable symbols of the collectable symbol set for that draw lottery ticket.

7. The lottery gaming system of claim 1, wherein the plurality of instructions, when executed by the processor, cause the processor to enable redemption of the quantity of the draw lottery tickets that comprise collectable symbols that form the winning combination, wherein the draw lottery tickets are from a pre-determined quantity of the drawings for the draw lottery game.

8. The lottery gaming system of claim 1, wherein the plurality of instructions, when executed by the processor, cause the processor to enable redemption of the quantity of the draw lottery tickets that comprise collectable symbols that form the winning combination, wherein the draw lottery tickets are from a quantity of sequential drawings of the drawings for the draw lottery game.

9. The lottery gaming system of claim 1, wherein the plurality of instructions, when executed by the processor, cause the processor to enable redemption of the quantity of the draw lottery tickets that comprise collectable symbols that form the winning combination, wherein the draw lottery tickets are from a plurality of the drawings for the draw lottery game during a predetermined time period.

10. The lottery gaming system of claim 1, wherein for one of the draw lottery tickets, the quantity of the collectable symbols of the collectable symbol set for that draw lottery ticket are the collectable symbols of the winning combination.

11. A lottery gaming system comprising:
a lottery terminal and associated draw lottery ticket printer; and
a central lottery server comprising a processor and a memory device that stores a plurality of instructions, that when executed by the processor, cause the processor to:
associate a draw lottery game with a collectable symbol set, the collectable symbol set comprising different collectable symbols and associated with a winning combination of the different collectable symbols;
thereafter, enable purchases of draw lottery tickets for each of a plurality of drawings of the draw lottery game,
wherein each of the draw lottery tickets comprises purchaser numbers for at least one of the plurality of drawings of the draw lottery game,
wherein each of the draw lottery tickets comprises one of:
a first quantity of the collectable symbols of the collectable symbol set, wherein the first quantity is zero,
a second quantity of the collectable symbols of the collectable symbol set, wherein the second quantity is one, and
a third quantity of the collectable symbols of the collectable symbol set, wherein the third quantity is more than one;
cause the lottery terminal and the draw lottery ticket printer to co-act to, for each of the draw lottery tickets, print the draw lottery ticket with the purchaser numbers and the collectable symbols of that draw lottery ticket;
for each of the plurality of drawings of the draw lottery game:
cause an indication of randomly determined drawn symbols for that drawing of the draw lottery game, and
cause a determination of any award amounts based on the drawn symbols for that drawing of the draw lottery game; and
enable redemption of a quantity of the draw lottery tickets that comprise collectable symbols that form the winning collectable symbol combination associated with the collectable symbol set.

12. The lottery gaming system of claim 11, wherein the plurality of instructions, when executed by the processor, cause the processor to, for each of the draw lottery tickets of the first group of draw lottery tickets, the second group of draw lottery tickets, and the group of draw lottery tickets, randomly determine the quantity of collectable symbols for that draw lottery ticket.

13. The lottery gaming system of claim 11, wherein the plurality of instructions, when executed by the processor, cause the processor to, for each of the draw lottery tickets of the second group of draw lottery tickets and the third group of draw lottery tickets, determine the quantity of collectable symbols for that draw lottery ticket based on a purchase amount for the draw lottery ticket.

14. The lottery gaming system of claim 11, wherein the plurality of instructions, when executed by the processor, cause the processor to, for each of the draw lottery tickets of the first group of draw lottery tickets and the second group of draw lottery tickets, determine the quantity of collectable symbols for that draw lottery ticket based on a quantity of the drawings of the draw lottery game the draw lottery ticket comprises.

15. The lottery gaming system of claim 11, wherein the plurality of instructions, when executed by the processor, cause the processor to, for each of the draw lottery tickets of the second group of draw lottery tickets and the third group of draw lottery tickets, randomly determine the collectable symbols for that draw lottery ticket.

16. A lottery gaming system comprising:
a lottery terminal and associated draw lottery ticket printer; and
a central lottery server comprising a processor and a memory device that stores a plurality of instructions, that when executed by the processor, cause the processor to:
associate a draw lottery game with a first collectable symbol set, the first collectable symbol set comprising first collectable symbols and associated with a first winning combination of the first collectable symbols;
associate a draw lottery game with a second collectable symbol set, the section collectable symbol set comprising second collectable symbols and associated with a second winning combination of the second collectable symbols;
thereafter, enable purchases of draw lottery tickets for each of a plurality of drawings of the draw lottery game,
wherein each of the draw lottery tickets comprises purchaser numbers for at least one of the plurality of drawings of the draw lottery game,
wherein each of the draw lottery tickets comprises a first quantity of the first collectable symbols of the first collectable symbol set,
wherein each of the draw lottery tickets comprises a second quantity of the second collectable symbols of the second collectable symbol set,
wherein one of the first quantity and the second quantity is at least one;
cause the lottery terminal and the draw lottery ticket printer to co-act to, for each of the draw lottery tickets, print the draw lottery ticket with the purchaser numbers and any of the first collectable symbols and the second collectable symbols of that draw lottery ticket;
for each of the plurality of drawings of the draw lottery game:
cause an indication of randomly determined drawn symbols for that drawing of the draw lottery game, and
cause a determination of any award amounts based on the drawn symbols for that drawing of the draw lottery game; and
enable redemption of a quantity of the draw lottery tickets that comprise either the first collectable symbols that form the first winning collectable symbol combination associated with the first collectable symbol set or the second collectable symbols that form the second winning collectable symbol combination associated with the second collectable symbol set.

17. The lottery gaming system of claim 16, wherein the plurality of instructions, when executed by the processor, cause the processor to, for each of the draw lottery tickets, randomly determine the quantity of first collectable symbols and the quantity of second collectable symbols for that draw lottery ticket.

18. The lottery gaming system of claim 16, wherein the first quantity is at least one and the second quantity is at least one.

19. The lottery gaming system of claim 16, wherein the plurality of instructions, when executed by the processor, cause the processor to, for each of the draw lottery tickets, determine the quantity of the first collectable symbols and the quantity of the second collectable symbols for that draw lottery ticket based on a quantity of the drawings of the draw lottery game the draw lottery ticket comprises.

20. The lottery gaming system of claim 16, wherein the plurality of instructions, when executed by the processor, cause the processor to, for each of the draw lottery tickets, randomly determine which of the first and second collectable symbols of the collectable symbol sets to employ for determining collectable symbols for that draw lottery ticket.
